(19) United States
(12) Patent Application Publication
(10) Pub. No.: US 2024/0311175 A1
(43) Pub. Date: Sep. 19, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Baoguo XIE, Shenzhen (CN); Manchang JU, Shenzhen (CN)

(73) Assignee: ZTE CORPORATION, Shenzhen (CN)

(21) Appl. No.: 18/616,370

(22) Filed: Mar. 26, 2024

Related U.S. Application Data
(63) Continuation of application No. PCT/CN2022/073256, filed on Jan. 21, 2022.

(51) Int. Cl. G06F 9/455

(52) U.S. Cl. CPC G06F 9/45558; G06F 2009/45595

(57) ABSTRACT

Method, device and computer program product for wireless communication are provided. A method includes: creating, by an orchestrator node, virtual link, VL, information according to virtual link descriptors, VLDs, and information of created cluster networks, wherein the VL information comprises the information of the created cluster networks mapping to relevant VLs, and an association between connection points, CPs, and the created cluster networks; and transmitting, by the orchestrator node to a virtualized network function manager node, a Containerized Virtualized Network Function, CNF, instantiating request comprising the VL information for instantiating CNFs for a Network Service, NS.

### CROSS-REFERENCE TO RELATED PATENT APPLICATIONS

This application is a Continuation of PCT Application No. PCT/CN2022/073256, filed Jan. 21, 2022, incorporated herein by reference in its entirety.

### TECHNICAL FIELD

This document is directed generally to wireless communications, and in particular to 5th generation (5G) communications.

### BACKGROUND

In NFV (Network Functions Virtualization) technology, the NFV-MANO (Network Functions Virtualization Management and Orchestration) is responsible for the lifecycle management of an NS (Network Service) and a CNF (Containerized VNF (Virtualized Network Function))/CNFC(Containerized VNF Component) based on the NS descriptor (NSD) and the VNF descriptor (VNFD). During the CNF lifecycle management (LCM) operation (e.g., the CNF instantiation), the VNFM (VNF manager) manages the CNF resources and requests the resource authorization for the VNF instantiation operation from the NFVO in accordance with the resource information in the VNFD. After the NFVO resource authorization is granted, the VNFM requests the CISM (Container Infrastructure Service Manager) to allocate corresponding container resources for the CNF instance. The CISM interacts with the NFVI (Network Functions Virtualization Infrastructure) platform for allocating container resources for the CNF instances. The CIS instances can provide the container resources. The NFV-MANO completes the VNF instantiation and successfully creates a CNF instance.

### SUMMARY

As described above, during the NS or the VNF LCM operation, the NFVO may request the CISM to create the cluster internal and/or external networks (also referred to as cluster internal/external networks or cluster external/internal networks) based on the attributes of a virtual link description (VLD). The VLD includes necessary information, such as the attributes of cluster internal/external networks, the attributes of VLs (virtual links) in associated with cluster networks, etc. The cluster internal/external networks are used for the network connections between the CNFs or the network connections between the internal CNFCs belonging to one CNF.

In NFV technology, the CCM is used for managing Container Infrastructure Service (CIS) cluster system. The CCM is responsible for performing the lifecycle management of the CIS clusters, including creating, deleting, and updating of the CIS clusters. The CCM is also responsible for allocating the container resources for the elements of the CIS clusters, which are the CIS instances and the CISMs. The container resources include computing resources, storage resources and network resources.

During the LCM operation of the CIS clusters, the CCM has the capability of creating the cluster internal/external networks independently. However, it is unclear how the NFV system interacts with the Container cluster system to use the cluster internal/external networks created by the CCM.

The present disclosure relates to methods, devices, and computer program products container network management.

One aspect of the present disclosure relates to a wireless communication method. In an embodiment, the wireless communication method includes: creating, by an orchestrator node, virtual link, VL, information according to virtual link descriptors, VLDs, and information of created cluster networks, wherein the VL information comprises the information of the created cluster networks mapping to relevant VLs, and an association between connection points, CPs, and the created cluster networks; and transmitting, by the orchestrator node to a virtualized network function manager node, a Containerized Virtualized Network Function, CNF, instantiating request comprising the VL information for instantiating CNFs for a Network Service, NS.

Another aspect of the present disclosure relates to a wireless communication method. In an embodiment, the wireless communication method includes: receiving, by a virtualized network function manager node from an orchestrator node, a Containerized Virtualized Network Function, CNF, instantiating request comprising virtual link, VL, information for instantiating CNFs for a Network Service, NS, wherein the VL information comprises information of created cluster networks mapping to relevant VLs, and an association between connection points, CPs, and the cluster networks.

Another aspect of the present disclosure relates to a wireless communication method. In an embodiment, the wireless communication method includes: receiving, by a service manager node from a virtualized network function manager node, virtual link, VL, information comprising information of created cluster networks and an association between connection points, CPs, and the cluster networks; and instantiating, by the service manager node, Containerized Virtualized Network Functions, CNFs, for a Network Service, NS, according to the VL information.

Another aspect of the present disclosure relates to a wireless communication method. In an embodiment, the wireless communication method includes: providing, by a container cluster manager node, information of created cluster networks, wherein the information of the cluster networks is used for an orchestrator node to create virtual link, VL, information for instantiating CNFs for a Network Service, NS, and the VL information comprises the information of the created cluster networks mapping to relevant VLs and an association between connection points, CPs, and the cluster networks.

Another aspect of the present disclosure relates to a wireless communication method. In an embodiment, the wireless communication method includes: providing, by an operation support node to an orchestrator node, a Network Service, NS, instantiating; and creating, by the orchestrator node, virtual link, VL, information for instantiating CNFs for a NS, and the VL information comprises information of created cluster networks mapping to relevant VLs, and an association between connection points, CPs, and the cluster networks.

Another aspect of the present disclosure relates to a wireless communication node. In an embodiment, the wireless communication node includes a communication unit and a processor. The processor is configured to create virtual link, VL, information according to virtual link descriptors, VLDs, and information of created cluster networks, wherein the VL information comprises the information of the created cluster networks mapping to relevant VLs, and an association between connection points, CPs, and the created cluster networks; and transmit, to a virtualized network function manager node, a Containerized Virtualized Network Function, CNF, instantiating request comprising the VL information for instantiating CNFs for a Network Service, NS.

Another aspect of the present disclosure relates to a wireless communication node. In an embodiment, the wireless communication node includes a communication unit and a processor. The processor is configured to receive, from an orchestrator node, a Containerized Virtualized Network Function, CNF, instantiating request comprising virtual link, VL, information for instantiating CNFs for a Network Service, NS, wherein the VL information comprises information of created cluster networks mapping to relevant VLs, and an association between connection points, CPs, and the cluster networks.

Another aspect of the present disclosure relates to a wireless communication node. In an embodiment, the wireless communication node includes a communication unit and a processor. The processor is configured to receive, from a virtualized network function manager node, virtual link, VL, information comprising information of created cluster networks and an association between connection points, CPs, and the cluster networks; and instantiate, by the service manager node, Containerized Virtualized Network Functions, CNFs, for a Network Service, NS, according to the VL information.

Another aspect of the present disclosure relates to a wireless communication node. In an embodiment, the wireless communication node includes a communication unit and a processor. The processor is configured to provide information of created cluster networks, wherein the information of the cluster networks is used for an orchestrator node to create virtual link, VL, information for instantiating CNFs for a Network Service, NS, and the VL information comprises the information of the created cluster networks mapping to relevant VLs, and an association between connection points, CPs, and the cluster networks.

Another aspect of the present disclosure relates to a wireless communication node. In an embodiment, the wireless communication node includes a communication unit and a processor. The processor is configured to provide, to an orchestrator node, a Network Service, NS, instantiating; and create virtual link, VL, information for instantiating CNFs for a NS, and the VL information comprises information of created cluster networks mapping to relevant VLs, and an association between connection points, CPs, and the cluster networks.

Various embodiments may advantageously implement the following features:

Preferably or in some embodiments, the method further comprises: creating, by the orchestrator node, NS VL information according to an external VLD of a Network Service Descriptor, NSD, wherein the NS VL information comprises information of a created NS cluster network and an association between external CPs of the CNFs and the created NS cluster network, and wherein the CNF instantiating request comprises the NS VL information.

Preferably or in some embodiments, the method further comprises: creating, by the orchestrator node, CNF VL information according to an internal VLD of a Virtualized Network Function Descriptor, VNFD, wherein the CNF VL information comprises information of created CNF cluster networks and an association between internal CPs of the CNFs and the created CNF cluster networks, and wherein the CNF instantiating request comprises the CNF VL information.

Preferably or in some embodiments, the method further comprises: receiving, by the orchestrator node from an operation support node, an NS instantiating request comprising an NSD, a VNFD, and attribute information of the cluster networks.

Preferably or in some embodiments, the method further comprises: receiving, by the orchestrator node from a container cluster manager node, the information of the created cluster networks.

Preferably or in some embodiments, the method further comprises: transmitting, by the orchestrator node to the container cluster manager node, a creating request comprising cluster network profiles to request the container cluster manager node to create the cluster networks according to the cluster network profiles.

Preferably or in some embodiments, the cluster network profiles are generated by the orchestrator node based on the VLDs, and the VLDs comprises attribute information for creating the cluster networks.

Preferably or in some embodiments, the method further comprises: transmitting, by the orchestrator node to the container cluster manager node, an allocation request to request the container cluster manager node to allocate one or more Container Infrastructure Service, CIS, clusters for the NS; and receiving, by the orchestrator node from the container cluster manager node, information of one or more allocated CIS clusters.

Preferably or in some embodiments, the method further comprises: receiving, by the orchestrator node from an operation support node, an NS instantiating request comprising an NSD and a VNFD and cluster network profiles.

Preferably or in some embodiments, the cluster networks are pre-configured by the container cluster manager node.

Preferably or in some embodiments, the method further comprises: updating, by the orchestrator node, the VL information according to updated VLDs; and transmitting, by the orchestrator node to the virtualized network function manager node, a new CNF instantiating request comprising the updated VL information for instantiating a new CNF for the NS.

Preferably or in some embodiments, the method further comprises: updating, by the orchestrator node, NS VL information according to an external VLD of an updated NSD.

Preferably or in some embodiments, the method further comprises: creating, by the orchestrator node, new CNF VL information for the new CNF according to an internal VLD of a new VNFD.

Preferably or in some embodiments, the method further comprises: transmitting, by the orchestrator node to a container cluster manager node, a creating request comprising a new CNF cluster network profile to control the container cluster manager node to create new cluster networks according to the new CNF cluster network profile; and receiving, by the orchestrator node to the container cluster manager node, information of the new cluster networks.

Preferably or in some embodiments, the VL information comprises NS VL information comprising information of an NS cluster network and an association between external CPs of the CNFs and the NS cluster network, and wherein the CNF instantiating request comprises the NS VL information.

Preferably or in some embodiments, the VL information comprises CNF VL information comprising information of CNF cluster networks and an association between internal CPs of the CNFs and the CNF cluster networks, and wherein the CNF instantiating request comprises the CNF VL information.

Preferably or in some embodiments, the method further comprises: creating, by the virtualized network function manager node, CNF VL information according to an internal VLD of a Virtualized Network Function Descriptor, VNFD, wherein the CNF VL information comprises information of CNF cluster networks and an association between internal CPs of the CNFs and the CNF cluster networks, and wherein the CNF instantiating request comprises the CNF VL information.

Preferably or in some embodiments, the method further comprises: transmitting, by the virtualized network function manager node to a service manager node, the VL information to allow the service manager to create CNF instances, create connections between the CNFs, create connections between Containerized Virtualized Network Function Components, CNFCs, in each CNFs, connect external CPs of the CNFs to an associated NS cluster network, and connect internal CPs of the CNFCs to CNF cluster networks.

Preferably or in some embodiments, the method further comprises: transmitting, by the virtualized network function manager node to a service manager node, updated VL information to allow the service manager to create connections between CNFCs in a new CNF and create connections between external CPs of the new CNF and an existing NS cluster network.

Preferably or in some embodiments, the method further comprises: creating, by the service manager node, connections between the CNFs; creating, by the service manager node, connections between Containerized Virtualized Network Function Components, CNFCs, in each CNFs; connecting, by the service manager node, external CPs of the CNFs to an associated NS cluster network; and connecting, by the service manager node, internal CPs of the CNFCs to CNF cluster networks.

Preferably or in some embodiments, the method further comprises: creating, by the service manager node, an NS cluster network and CNF cluster networks according to a NS cluster network profile and CNF cluster network profiles.

Preferably or in some embodiments, the method further comprises: receiving, by the service manager node from the virtualized network function manager node, updated VL information; and creating, by the service manager node, network connections for a new CNF instance according to the updated VL information.

Preferably or in some embodiments, the method further comprises: receiving, by the container cluster manager node from an operation support node or the orchestrator node, a creating request comprising cluster network profiles; creating, by the container cluster manager node, cluster networks as the created cluster networks for the orchestrator node according to the cluster network profiles; and

Preferably or in some embodiments, the method further comprises: transmitting, by the container cluster manager node to the operation support node or the orchestrator node, the information of the created cluster networks.

Preferably or in some embodiments, the method further comprises: receiving, by the container cluster manager node from an operation support node, an allocation request for one or more Container Infrastructure Service, CIS, clusters for the NS; and transmitting, by the container cluster manager node to the operation support node, information of one or more allocated CIS clusters.

Preferably or in some embodiments, the method further comprises: pre-configuring, by the container cluster manager node, cluster networks according to local cluster network profiles.

Preferably or in some embodiments, the method further comprises: receiving, by the container cluster manager node from the orchestrator node, an allocation request for one or more CIS clusters for the NS; transmitting, by the container cluster manager node to the orchestrator node, information of one or more allocated CIS clusters; and receiving, by the container cluster manager node from the orchestrator node, information of one or more selected CIS clusters.

Preferably or in some embodiments, the method further comprises: transmitting, by the container cluster manager node to the orchestrator node, information of a new created CNF cluster network; updating, by the orchestrator node, NS VL information according to existing NS VL information, an updated NSD, and a new CNFD; and creating, by the orchestrator node new VL information according to the information of the new created CNF cluster network and an internal VLD of a new VNFD.

Preferably or in some embodiments, the method further comprises: receiving, by the container cluster manager node from the orchestrator node, a creating request comprising a cluster network profile for a new CNF for creating the new created CNF cluster network; and transmitting, by the container cluster manager node to the orchestrator node, the information of the new created CNF cluster networks.

Preferably or in some embodiments, the method further comprises: transmitting, by the operation support node to a container cluster manager node, a creating request comprising cluster network profiles to request the container cluster manager node to create cluster networks according to the cluster network profiles; and receiving, by the operation support node from the container cluster manager node, the information of the created cluster networks.

Preferably or in some embodiments, the method further comprises: transmitting, by the operation support node to a container cluster manager node, an allocation request to request the container cluster manager node to allocate one or more Container Infrastructure Service, CIS, clusters for the NS; and receiving, by the operation support node to a container cluster manager node, information of one or more allocated CIS clusters.

Preferably or in some embodiments, the method further comprises: transmitting, by the operation support node to a container cluster manager node, a request for instantiating a new CNF, wherein the request comprises an updated Network Service Descriptor, NSD, and a new Virtualized Network Function Descriptor, VNFD.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of an NFV system according to an embodiment of the present disclosure.

FIG. 2 shows a schematic diagram of a CIS cluster system according to an embodiment of the present disclosure.

FIG. 3 shows a schematic diagram of a process according to an embodiment of the present disclosure.

FIGS. 4A and 4B show a schematic diagram of a process according to an embodiment of the present disclosure.

FIGS. 5A and 5B show a schematic diagram of a process according to an embodiment of the present disclosure.

FIGS. 6A and 6B show a schematic diagram of a process according to an embodiment of the present disclosure.

FIGS. 7A and 7B show a schematic diagram of a process according to an embodiment of the present disclosure.

FIG. 8 shows an example of a schematic diagram of a wireless network node according to an embodiment of the present disclosure.

### DETAILED DESCRIPTION

The present disclosure provides a method and system for container network management. In the CIS cluster system, the CCM can pre-created the cluster internal/external networks based on the network requirements or the network configuration profiles. In the NFV system, when a NS or a CNF performs lifecycle management operations, the NFV-MANO can interact with the CCM to reuse the existing cluster internal/external networks created by the CCM. In such a manner, the usage of the network resources can be reduced, the network creating process can be simplified, and the user experience can be improved.

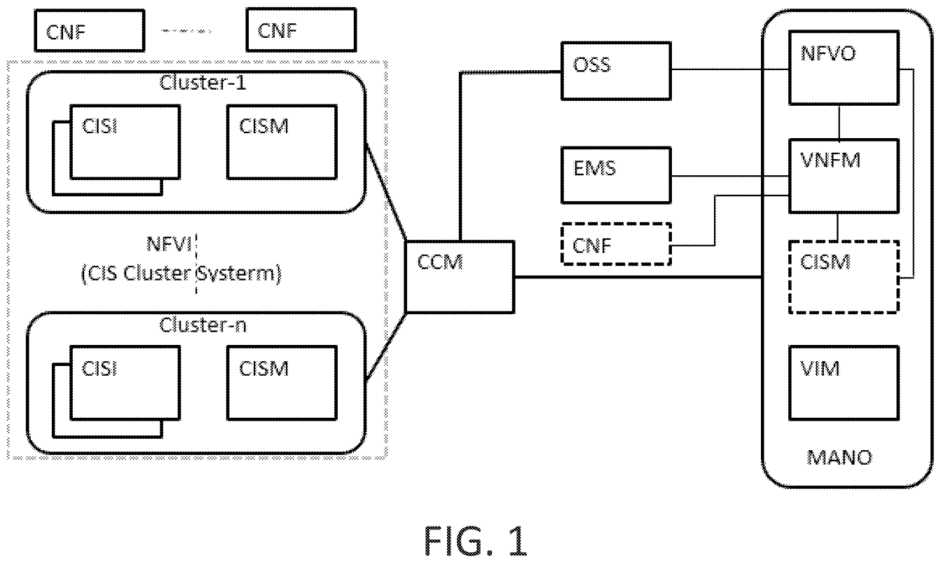

FIG. 1 shows a schematic diagram of an NFV system according to an embodiment of the present disclosure. The NFV system includes multiple functional blocks.

The following functional blocks are a part of the NFV-MANO, including:
Network Functions Virtualization Orchestrator (NFVO);
Virtualized Network Function Manager (VNFM);
Virtualized Infrastructure Manager (VIM); and
Container Infrastructure Service Manager (CISM).

Additional functional blocks in the NFV system interacting with the NFV-MANO functional blocks are:
Element Management (EM);
Virtualized Network Function (VNF);
Operation Support System (OSS) and Business Support System functions (BSS); and
NFV Infrastructure (NFVI).

The CISM is responsible for container management and orchestration. The CISM can manage container objects (e.g., Kubernetes® Pods) and container related virtualized resources.

The CISI (Container Infrastructure Service Instance) provides the Container Infrastructure resources within the NFVI Virtualization Layer and provides the container runtime environment.

The CISM can interact with the CISI to create all managed container objects, which are the components of the CNF (e.g., container-based VNF), and allocate the container resources to these components during the LCM operations (e.g., the CNF instantiation) of these components.

The NFV system is enhanced to support Container cluster management and orchestration. The CCM is responsible for the lifecycle management of the container clusters, including creating, updating, and deleting the container clusters.

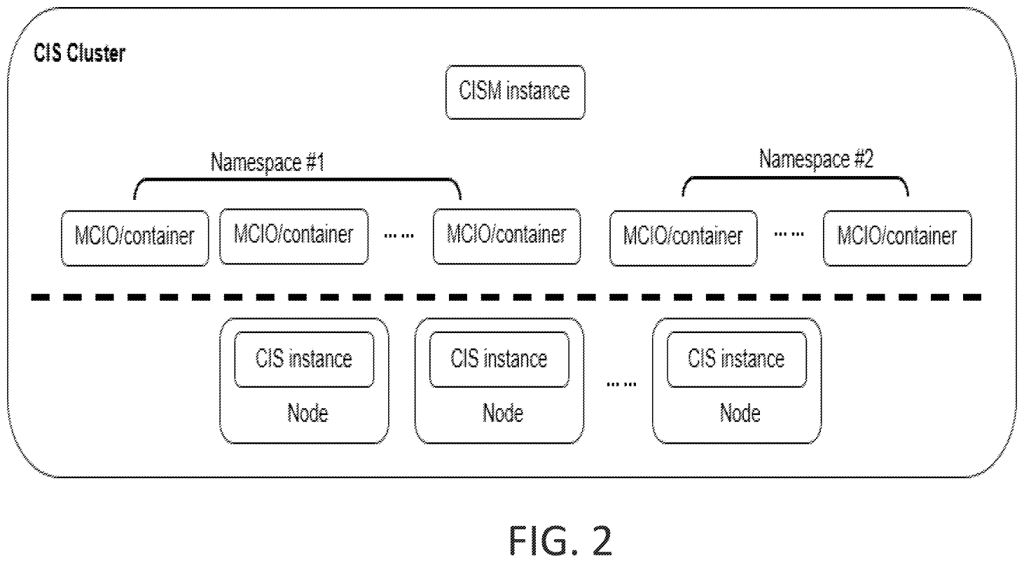

FIG. 2 shows a schematic diagram of a CIS cluster system according to an embodiment of the present disclosure. In the CIS cluster system, the CCM is responsible for creating CIS clusters on the NFVI. The CIS cluster can be created by using virtual resources (e.g., on virtual machines) or physical resources (e.g., on physical servers).

The CCM creates CIS clusters according to the requirements of the telecom operators and third parties. A CIS cluster includes a CISM instance and one or multiple cluster nodes where the Container Infrastructure Service (CIS) instances are hosted. The CISM instance schedules the Managed Container Infrastructure Objects (MCIOs) invoked by the CNF with corresponding cluster nodes in the CIS cluster. The CCM can control the CISM to perform LCM operations of the CIS clusters, the CISM has the capability to control the CIS instances to provide the container resources.

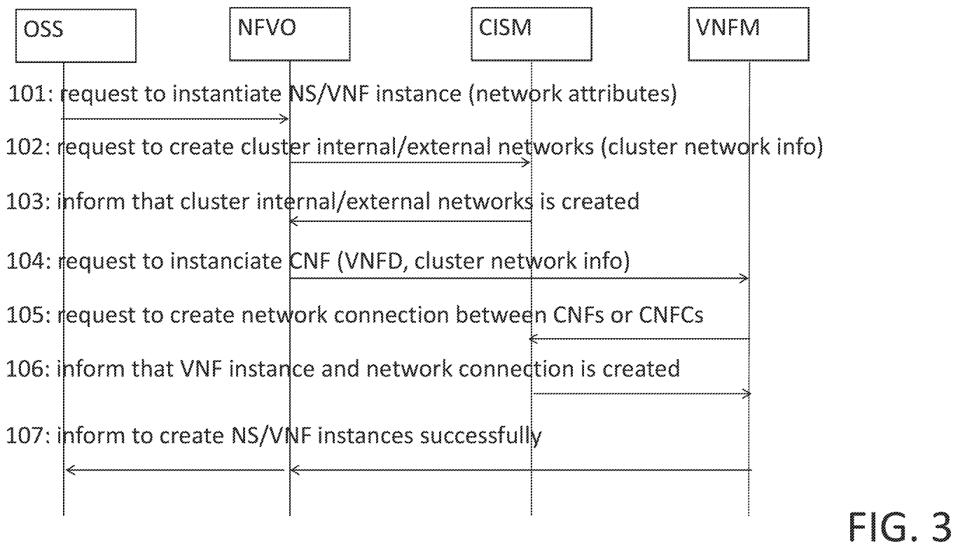

FIG. 3 shows a schematic diagram of a procedure for creating an NS or CNF instances according to an embodiment of the present disclosure.

Step 101: The OSS requests the NFVO to instantiate an NS or CNFs with the NSD and the VNFD, in which the network attributes for creating VLs and cluster internal/external networks are described in the NSD and the VNFD.

Step 102: The NFVO requests the CISM to create the cluster internal/external networks with the cluster network information. The created cluster internal/external network used for the network connections between the CNFs (which is called NS cluster network, NS cluster internal/external network, or NS cluster external/internal network) is based on the network attributes described in the NSD. The created Cluster internal/external networks used for the network connections between CNFCs inside the same CNFs (which are called CNF cluster networks, CNF cluster internal/external networks, or CNF cluster external/internal networks) are based on the network attribute described in the VNFDs.

Step 103: The CISM performs the operation to create the cluster internal/external networks based on the cluster network information from the NFVO. The CISM informs the NFVO that the cluster internal/external networks are created successfully with the information of the NS cluster network and the CNF cluster networks.

Step 104: The NFVO requests the VNFM to instantiate the CNFs with the VNFD and the information of the NS cluster network and the CNF cluster networks.

Step 105: The VNFM requests the CISM to create the CNF instances and the network connections between the CNFs and the CNFCs with the information of the CNFs and the information of the NS cluster network and the CNF cluster networks.

Step 106: The CISM performs the creating operation of the CNFs, including creating the CNFCs (which may be composed of containers) and allocating computing resources and storage resources for the CNFCs. The CISM connects the external CPs (connection points) of the CNFs to the associated NS cluster network, and connect the internal CPs of the CNFCs to the CNF cluster networks.

The CISM informs the VNFM that the CNF instances are created successfully.

Step 107: The NFVO and The OSS are informed that the NS instance or the CNF instances are instantiated successfully.

In some embodiments of the present disclosure, the CCM creates the cluster external networks and cluster internal networks in the CIS clusters. The MANO can use the created cluster external networks and cluster internal networks as the external VL network (also referred to as external VL) of the NS instance and as the internal VL networks (also referred to as internal VLs) of the CNF instances.

In some embodiments, there are some options for the CCM to create the cluster external networks and cluster internal networks.

(1) The OSS requests the CCM to pre-create the cluster external networks and the cluster internal networks before the NS LCM or CNF LCM operation based on the cluster network profiles provided by the OSS.

(2) During the NS LCM operation or CNF LCM operation, the NFVO requests the CCM to create the cluster external networks and the cluster internal networks based on the cluster network profiles provided by the NFVO.

(3) The CCM can pre-configure the cluster external networks and the cluster internal networks based on the CIS cluster descriptor or the pre-configured cluster network profiles.

In the case of instantiating the NS or adding a new CNF instance to a NS instance, after the NFVO receives the information of the NS cluster network and the CNF cluster networks, one or more of the following operations may be performed.
The NFVO may map the external VL with the NS cluster network, and map the external CPs with the NS cluster network. Afterward, the NFVO may create NS VL information for the network connections among the CNFs belonging to the NS.
The NFVO or the VNFM may map the internal VLs and the CNF cluster networks, and internal CPs and CNF cluster networks. Afterward, the NFVO may create CNF VL information for the network connections among the CNFCs belonging a CNF.
For mapping the external VL with the NS cluster network, each external VL object can associate to a network object of the NS cluster network based on the same names or the same types.
For mapping external CPs with the NS cluster network, each external CP can associate to a network object of the NS cluster network based on the same associated external VL.
For mapping internal VLs with the CNF cluster networks, each internal VL object can associate to a network object of the CNF cluster networks based on the same names or the same types.
For mapping internal CPs with CNF cluster networks, each internal CP can associate to a network object of the CNF cluster networks based on the same associated internal VL.
The NFVO may request the VNFM to instantiate the CNFs with the NS VL information and the CNF VL information. The NS VL information is used to create the network connections between the external CPs of the CNFs and the NS cluster external/internal network. The CNF VL information is used to create the network connections between the internal CPs of the CNFCs and the CNF cluster external/internal networks.
The VNFM may request the CISM to create the CNF instances and the network connections between the CNFs, and the network connections between the CNFCs inside the same CNF with the NS VL information and the CNF information.
The CISM may connect the external CPs of the CNFs to the associated NS cluster network, and connect the internal CPs of the CNFCs to the CNF cluster networks based on the NS VL information and the CNF VL information.
After the CNF instances are successfully instantiated, and the network connections are successfully created, the CISM may inform the VNFM that the CNF instances are created successfully, and the VNFM may inform CNF instances are instantiated successfully.
After all CNFs are created successfully, and the network connections between the CNFs are created, the NFVO may inform the OSS that the NS instance is created successfully.

### Embodiment 1: CCM Pre-Creates Cluster Internal/External Networks

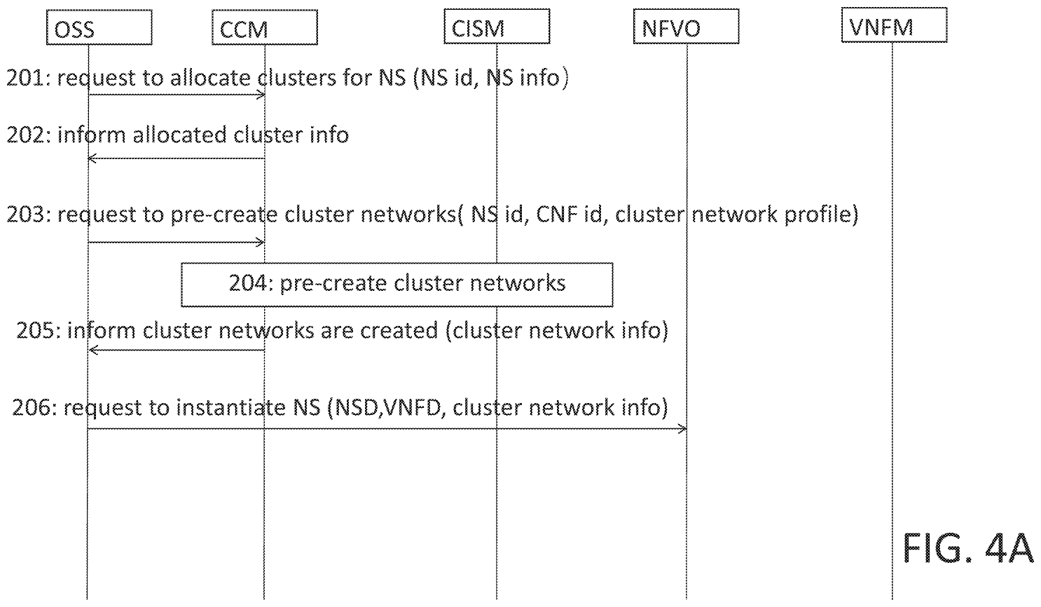

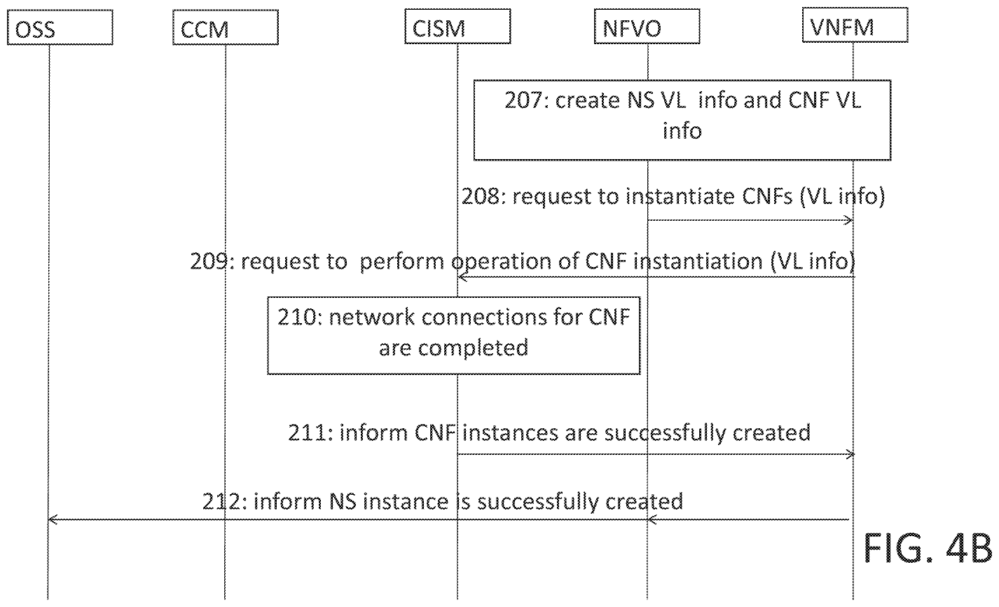

FIG. 4 shows a schematic diagram of a process according to an embodiment of the present disclosure. In this embodiment, the CCM can pre-create the cluster external/internal networks for providing virtual networks for the NS instance and the CNF instances before the NS or CNF instantiation is initiated by the OSS.

In an embodiment, the CCM pre-creates the cluster external/internal networks based on the cluster network profiles provided by the OSS.

In an embodiment, the NFVO maps external VL with the NS cluster network, and maps external CPs with the NS cluster network. The NFVO may create NS VL information for the network connections among the CNFs belonging to the NS.

In an embodiment, the NFVO or the VNFM may map internal VLs with a CNF cluster network, and map internal CPs with CNF cluster networks. The NFVO may create CNF VL information for the network connections among CNFCs belonging to one of the CNFs.

Step 201: The CCM creates multiple CIS clusters for the CNF and NS lifecycle managements.

The OSS transmits a request message to the CCM to request to allocate one or more useable CIS clusters for an NS instance. The request message includes at least one of: the NS ID (identifier) and/or the required container resources for the NS instance.

Step 202: The CCM allocates one or more CIS clusters for the NS instance. The CCM ensures that these allocated CIS clusters can provide the required container resources for the NS instance. The CCM informs the OSS the information of the allocated CIS clusters by transmitting the CIS cluster IDs of the allocated CIS clusters.

Step 203: The OSS requests to pre-create cluster networks for a NS and all constituent CNFs of the NS by transmitting a request message to the CCM. The request message includes at least one of: the NS ID, the cluster network profile for the NS, the CNF IDs of the constituent CNFs of the NS, and/or the cluster network profiles for the CNFs of the NS.

The cluster network profile for the NS and the cluster network profiles for the CNFs of the NS are used for defining the attributes of the cluster internal/external networks. The attributes can include at least one of: the name of the network object in the cluster internal/external networks, the type of the network object, CNI (Container Network Interface) plugin information of the network object, QoS (Quality of Service) of the network object, the network address of the network object, and/or the port number of the network object. For example, the type of the network object in the cluster internal/external networks can be a control network, a signal network, a charging network, or a management network.

Step 204: The CCM receives the request message from the OSS, and requests the CISM to create the cluster networks for the NS and all of the CNFs of the NS based on the cluster network profile for the NS and the cluster network profiles for the CNFs of the NS.

The CISM creates the cluster internal/external network for the NS (referred to as the NS cluster internal/external network) based on the cluster network profile for the NS. The CISM creates the cluster internal/external networks for the CNFs (referred to as the CNF cluster internal/external networks) based on the cluster network profiles for the CNFs of the NS. The CISM returns the information of the created NS cluster internal/external network and CNF cluster internal/external networks to the CCM.

Step 205: The CCM informs the OSS that the cluster networks are successfully created with an informing message. The informing message includes the information of the created NS cluster internal/external network and CNF cluster internal/external networks.

Step 206: The OSS requests to instantiate the NS for creating the NS instance with the NSD, all needed VNFDs, and cluster information. The cluster information includes the allocated cluster ID and the information of the created NS cluster internal/external network and the created CNF cluster internal/external networks. In an embodiment, the OSS transmits attribute information of the cluster networks to the NFVO.

In the NSD, the attributes of the external VL network are described in the external VLD. In the VNFD, the attributes of the internal VL networks are described in the internal VLD. In order to map the VL networks with the cluster networks, the types or the names of the objects in the external VL described in the external VLD can be the same as the types or the names of the objects in the associated NS cluster network. The types or the names of the objects in the internal VLs described in the internal VLD can be the same as the types or the names of the objects in the associated CNF cluster networks. An external VL is a virtual network used for the external network connections among CNFs belonging to one NS, and an internal VL is a virtual network used for the internal network connections among CNFCs belonging to one CNF.

Step 207: The NFVO performs the creation of the external VL which is described in the external VLD of the NSD. The NFVO or the VNFM may perform the creation of the internal VL which is described in the internal VLD of the VNFD.

According to the received cluster information, the NFVO knows that the CCM has created the NS cluster internal/external network and the CNF cluster internal/external networks for the external VL and the internal VLs. The NFVO or the VNFM may use the NS cluster internal/external network as the external VL network according to the NS ID, and use the CNF cluster internal/external networks as the internal VL networks according to the CNF IDs.

The NS cluster network and the CNF cluster networks have multiple cluster network objects. The external VL and the internal VLs have multiple VL objects. Each of the VL objects is associated with one of the cluster network objects. In an embodiment, each of the VL objects is associated with one of the cluster network objects based on the names and/or the types of the VL objects and the cluster network objects.

In the NSD, there is an external CP descriptor describing the VL objects which the external CPs of the CNF can connect to. An external CP is used for the network connections between constituent CNFs of a NS. In a VNFD, there is an internal CP descriptor describing the VL objects which the internal CPs of the CNFs can connect to. An internal CP is used for the network connections between constituent CNFCs of a CNF. The NFVO or the VNFM may build the association between the CPs and cluster network objects based on the associated VLs.

The NFVO may create the NS VL information providing the information of the NS cluster external/external network, and the association between the external CPs of the CNFs and the NS cluster external/internal network.

Optionally, the NFVO may create the CNF VL information providing the information of the CNF cluster external/external networks, and the associations between internal CPs of the CNFs and the CNF cluster external/internal networks.

Step 208: The NFVO requests the VNFM to instantiate the CNF with the NS VL information, and optionally, with the CNF VL information as well. The NS VL information is used to create the network connections between the external CPs of the CNFs and the NS cluster external/internal network, the CNF VL information is used to create the network connections between the internal CPs of the CNFCs and the CNF cluster external/internal networks.

Step 209: If the NFVO does not provide the CNF VL information, the VNFM may create the CNF VL information providing the information of the CNF cluster external/external networks, and the association between internal CPs of the CNFs and the CNF cluster external/internal networks.

The VNFM requests the CISM to create the CNF instances and the network connections between the CNFs, and the network connections between the CNFCs inside each CNF with the NS VL information and the CNF information.

Step 210: The CISM performs the creation of the CNF instances, creates the CNFCs (which are composed of containers), allocating compute resources and storage resources for the CNFCs. The CISM connects the external CPs of the CNFs to the associated NS cluster network, and connects the internal CPs of the CNFCs to the CNF cluster networks based on the NS VL information and the CNF VL information.

Step 211: After the CNF instances are successfully instantiated and the network connections are successfully created, the CISM informs the VNFM that the CNF instances are created successfully.

Step 212: The VNFM informs the NFVO the CNF instances is instantiated successfully. After all CNF instances are created successfully, and the network connections between the CNFs are created, the NFVO informs the OSS that the NS instance is created successfully.

### Embodiment 2: Create Cluster Internal/External Networks During the NS LCM

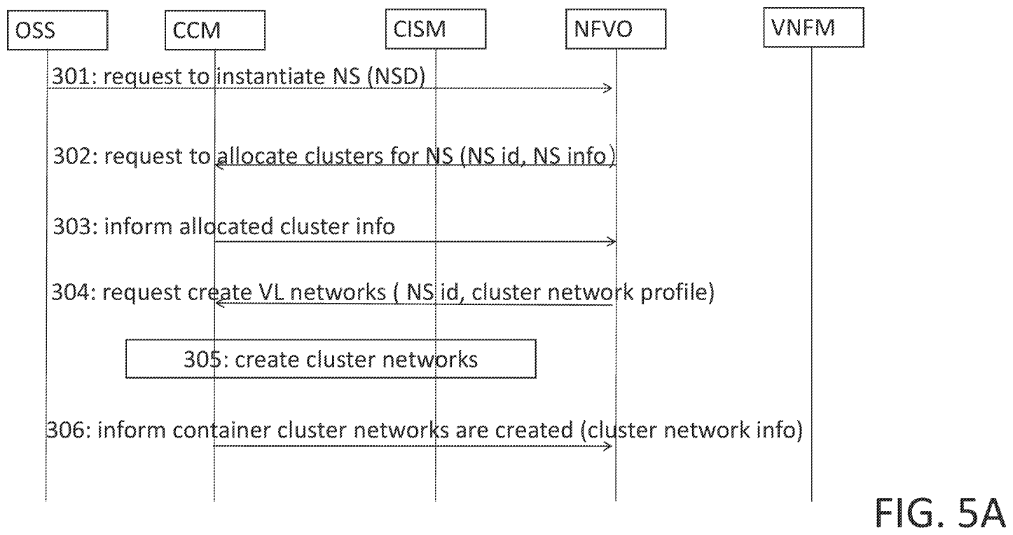

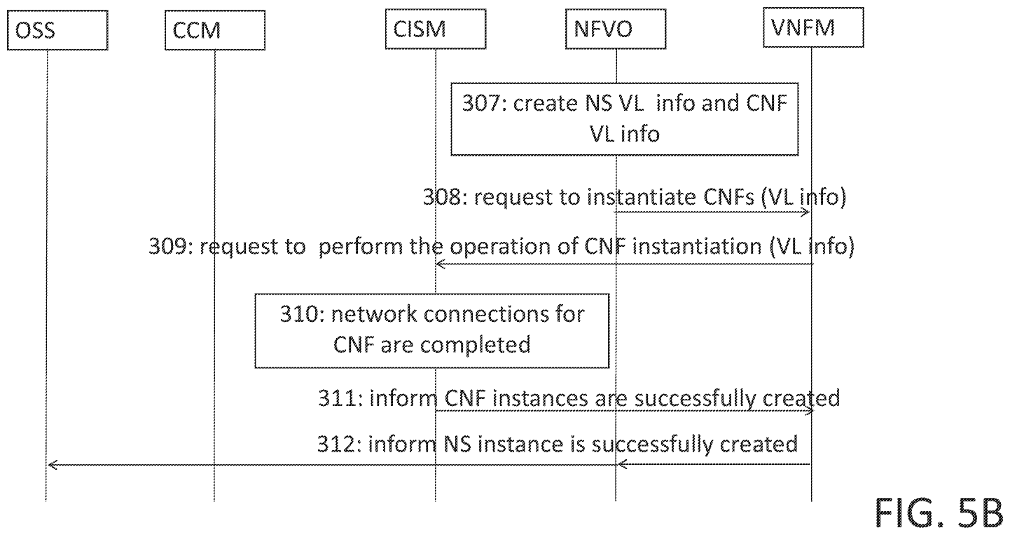

FIG. 5 shows a schematic diagram of a process according to an embodiment of the present disclosure. In this embodiment, the CCM can create the cluster external networks and cluster internal networks for providing virtual networks for an NS instance and CNF instances during an NS instantiation.

After receiving the request of an NS instantiation from the OSS, the NFVO requests the CCM to allocate the needed CIS clusters for providing the required container resources of the NS instance, and requests the CCM to initiate the creation of VL networks with the NS and CNF cluster network profiles. The NS and CNF cluster network profiles can be created by the NFVO based on the network attributes described in the NSD or VNFD. Alternatively, the NS and CNF cluster network profiles can be provided from the OSS to the NFVO.

The CCM creates the needed cluster external networks and cluster internal networks based on the NS and CNF cluster network profiles provided by the NFVO.

The NFVO maps an external VL with an NS cluster network, and the external CPs with the NS cluster network. Then, the NFVO may create NS VL information for the network connections among CNFs belonging to one NS.

The NFVO maps internal VLs with CNF cluster networks, and internal CPs with CNF cluster networks, then the NFVO may create CNF VL information for the network connections among CNFCs belonging to one CNF.

Step 301: The OSS requests the NFVO to instantiate an NS for creating a NS instance with an NSD and all needed VNFDs. The NSD includes the information of the NS cluster internal/external network which is defined in the external VLD of the NSD. The VNFD includes the information of the CNF cluster internal/external networks which is defined in the internal VLD of VNFD.

Optionally, the request message from the OSS to the NFVO may include an NS cluster network profile and CNF cluster network profiles which is used to describe the information of the NS and CNF cluster internal/external networks.

Step 302: After received the request for instantiating the NS from the OSS, the NFVO may need to request the CCM to create VL networks for the NS instance and the CNF instances.

The OSS may create the NS cluster network profile according to the information of the NS cluster internal/external network defined in the external VLD of the NSD, and create the CNF cluster network profiles according to the information of the CNF cluster internal/external networks defined in the internal VLD of VNFD.

Then, the NFVO requests the CCM to allocate one or more useable CIS clusters for the NS instance. In the request message, the NS ID and the required container resources for the NS instance are provided to the CCM.

Step 303: The CCM allocates one or more CIS clusters for the NS instance, the CCM makes sure that these allocated CIS clusters can provide the required container resources for the NS instance. The CCM informs to the NFVO the information of allocated CIS clusters identified by CIS cluster ID.

Step 304: The NFVO requests the CCM to create VL networks with the NS cluster profile and the CNF cluster profiles. The request message includes the NS ID associated with the NS cluster network profile and the CNF IDs associated with the CNF cluster network profiles.

The NS cluster network profile and CNF cluster network profiles are used for defining the attributes of the NS cluster internal/external network or CNF cluster internal/external networks. The attributes can include at least one of: the name of the network object in the cluster internal/external networks, the type of the network object, CNI (Container Network Interface) plugin information of the network object, QoS (Quality of Service) of the network object, the network address of the network object, and/or the port number of the network object. For example, the type of the network object in the cluster internal/external networks can be a control network, a signal network, a charging network, or a management network.

Step 305: The CCM receives the request message from the NFVO, and requests the CISM to create the NS cluster network and the CNF cluster networks based on the NS cluster network profile and the CNF cluster network profiles.

The CISM creates the NS cluster internal/external network and the CNF cluster internal/external networks. Then, the CISM returns the information of the NS cluster internal/external network and CNF cluster internal/external networks to the CCM.

Step 306: The CCM informs the NFVO that the NS cluster network and the CNF cluster networks are successfully created. In the informing message, the information of the NS cluster internal/external network and CNF cluster internal/external networks are provided to the NFVO.

Step 307: The NFVO associates each object of the external VL to a different network object of the NS cluster network based on the definition in the external VLD of the NSD, and each objects of the internal VLs to a different network object of the CNF cluster networks based on the definition in the internal VLD of the VNFD. The association relationship can be specified in the VLD, or the VL objects and cluster network objects can be associated each other with the same names or the same types.

In the NSD or the VNFD, there is an external CP descriptor or internal CP descriptor describing the VL objects which the external CPs or internal CPs of the CNFs can connect to. The NFVO may establish the association between the external CPs and NS cluster external/internal network, and the association between the internal CPs and CNF cluster external/internal networks based on the associated VLs.

The NFVO may create the NS VL information providing the information of the NS cluster external/external network, and the association between the external CPs of the CNFs and NS cluster external/internal network.

The NFVO may create the CNF VL information providing the information of the CNF cluster external/external networks, and the associations between internal CPs of the CNFs and the CNF cluster external/internal networks.

Step 308: The NFVO requests the VNFM to instantiate the CNF with the NS VL information and CNF VL information. The NS VL information is used to create the network connections between the external CPs of the CNFs and the NS cluster external/internal network, the CNF VL information is used to create the network connections between the internal CPs of the CNFCs and the CNF cluster external/internal networks.

Step 309: The VNFM requests the CISM to create the CNF instances and the network connections between the CNFs, and the network connections between the CNFCs inside each CNF with the NS VL information and the CNF information.

Step 310: The CISM performs the creation of the CNF instances, creates the CNFCs (which are composed of containers), allocating compute resources and storage resources for the CNFCs. The CISM connects the external CPs of the CNFs to the associated NS cluster network, and connects the internal CPs of the CNFCs to the CNF cluster networks based on the NS VL information and the CNF VL information.

Step 311: After the CNF instances are successfully instantiated and the network connections are successfully created, the CISM informs the VNFM that the CNF instances are created successfully.

Step 312: The VNFM informs the NFVO the CNF instances is instantiated successfully. After all CNF instances are created successfully, and the network connections between the CNFs are created, the NFVO informs the OSS that the NS instance is created successfully.

### Embodiment 3: Create Cluster Internal/External Networks During the CNF LCM

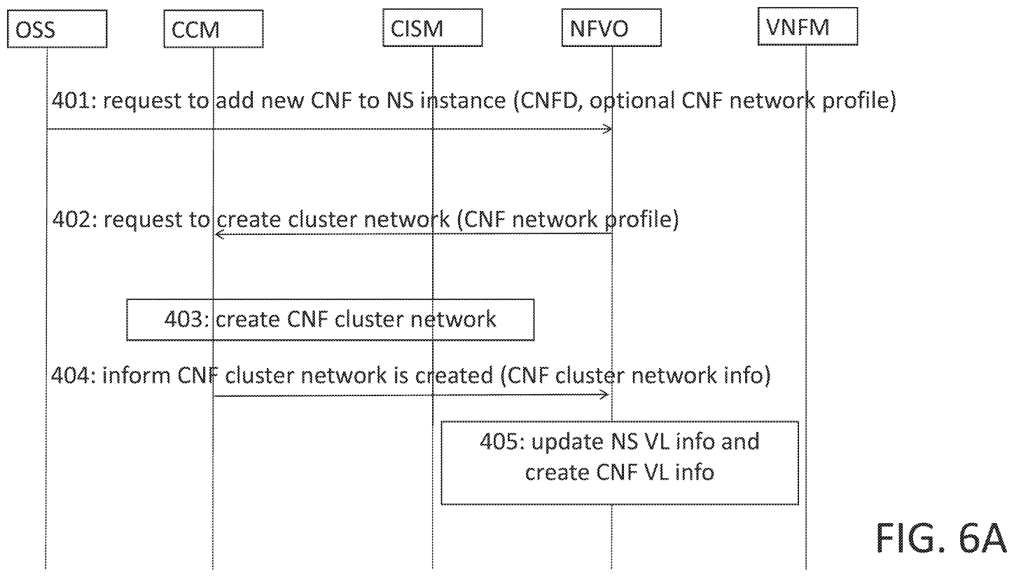

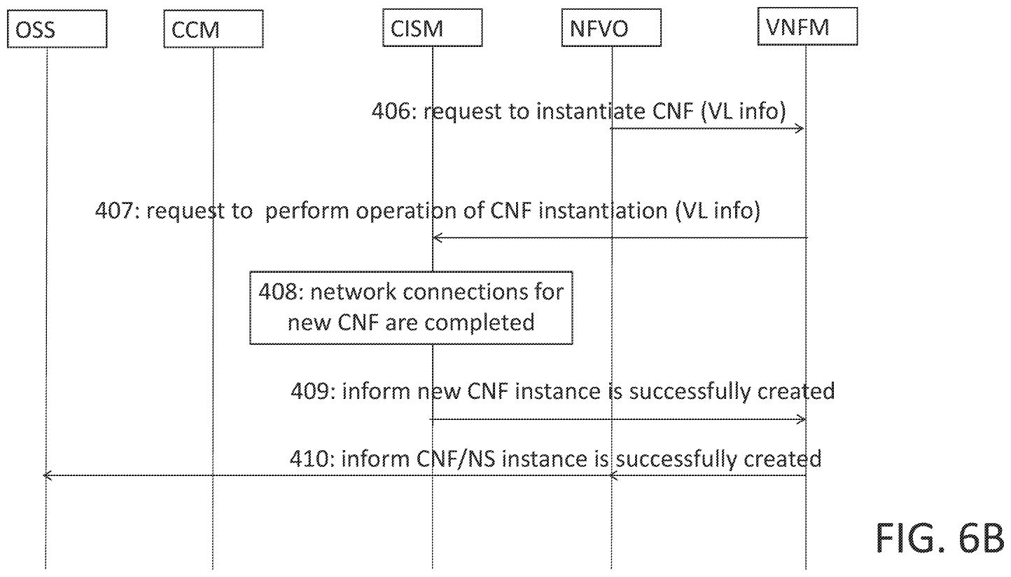

FIG. 6 shows a schematic diagram of a process according to an embodiment of the present disclosure. In this embodiment, the CCM can creates the cluster external networks and cluster internal networks for providing virtual networks for a new added CNF instance during the CNF instantiation.

After receiving the request of a CNF instantiation from the OSS, the NFVO requests the CCM to create new VL networks with a new CNF cluster network profile. The new CNF cluster network profile can be created by the NFVO based on the network attributes described in the VNFD, or the new CNF cluster network profile can be provided from the OSS to the NFVO.

The CCM creates the needed cluster external networks and the cluster internal networks based on the new CNF cluster network profile provided by the NFVO.

The NFVO may update the existing NS VL information to add the information of the NS cluster network objects which the external CPs of the new CNF can connect to.

The NFVO may map the internal VL with the new CNF cluster network, and the internal CPs with the new CNF cluster network, then the NFVO may create new CNF VL information for the network connections among CNFCs belonging to the new CNF.

Step 401: The OSS requests the NFVO to instantiate a new CNF to be added to a NS instance with the a VNFD corresponding to the new CNF and an updated NSD corresponding to the NS instance. The VNFD includes the information of the CNF cluster internal/external network defined in the internal VLD of the VNFD.

Optionally, the request message from the OSS to the NFVO can include the CNF cluster network profile which is used to describe the information of the CNF cluster internal/external network.

In addition, the CPD and VLD are updated to describe the association between the external CPs of the new CNF and the external VL in the updated NSD.

Step 402: After received the request, the NFVO needs to request the CCM to create the VL networks for the new CNF instance.

If there is no CNF cluster network profile in the request message from the OSS, the NFVO creates the CNF cluster network profile according to the information of the CNF cluster internal/external network defined in the internal VLD of the VNFD.

Step 402: The NFVO requests the CCM to create an internal VL network with the CNF cluster profile. In the message, the CNF ID is associated with the cluster network profile for the CNF.

The cluster network profile is used for defining the attributes of the cluster internal/external network. The attributes can include at least one of: the name of the network object in the cluster internal/external networks, the type of the network object, CNI (Container Network Interface) plugin information of the network object, QoS (Quality of Service) of the network object, the network address of the network object, and/or the port number of the network object. For example, the type of the network object in the cluster internal/external networks can be a control network, a signal network, a charging network, or a management network.

Step 403: The CCM receives the request message from the NFVO, and requests the CISM to create the CNF cluster network based on the CNF cluster network profile.

The CISM creates the CNF cluster internal/external network, and then the CISM returns the information of the CNF cluster internal/external network to the CCM.

Step 404: The CCM informs the NFVO that the CNF cluster network is successfully created. In the informing message, the information of the CNF cluster internal/external network is provided to the NFVO.

Step 405: the NFVO associates each object of the internal VL to a different network object of the CNF cluster network based on the definition in the internal VLD of the VNFD. The association therebetween can be specified in the VLD, or the VL objects and cluster network objects can be associated each other with the same names or the same types.

For the new CNF instance, the external CPs thereof are associated with an existing external VL which is described in the updated NSD. The NFVO may update the existing NS VL information to add the association between the external CPs of the new CNF and the existing NS cluster external/internal network.

In the VNFD, there is an internal CP descriptor describing the internal VL objects which the internal CPs of the CNF can connect to. The NFVO may establish the association between the internal CPs and the CNF cluster network objects based on the associated VL objects.

The NFVO may create the new CNF VL information to providing the information of the new CNF cluster external/external network, and the association between the internal CPs of the new CNF and the new CNF cluster external/internal network.

Step 406: The NFVO requests to instantiate the new CNF to the VNFM with the information of the updated NS VL information and the new CNF VL information. The updated NS VL information is used to create the network connections between the external CPs of the new CNF and the existing NS cluster external/internal network. The new CNF VL information is used to create the network connections between the internal CPs and the new CNF cluster external/internal network.

Step 407: The VNFM requests the CISM to create the new CNF instance and the network connections between the new CNF and other existing CNFs, and the network connections between CNFCs inside the new CNF according to the updated NS VL information and the new CNF information.

Step 408: The CISM create the new CNF instance, create the CNFCs (which are composed of containers), and allocate computing resources and storage resources for CNFCs. The CISM connects the external CPs of the new CNF to the associated NS cluster network, and connects the internal CPs of the CNFCs to the CNF cluster networks based on the updated NS VL information and the new CNF information.

Step 409: After the new CNF instance is successfully instantiated, and the network connections are successfully created, the CISM informs the VNFM that the new CNF instance is created successfully.

Step 410: The VNFM informs the NFVO that the new CNF instance is created successfully. The NFVO informs the OSS that the new CNF instance is created successfully.

### Embodiment 4: Pre-Configure Cluster Networks by the CCM

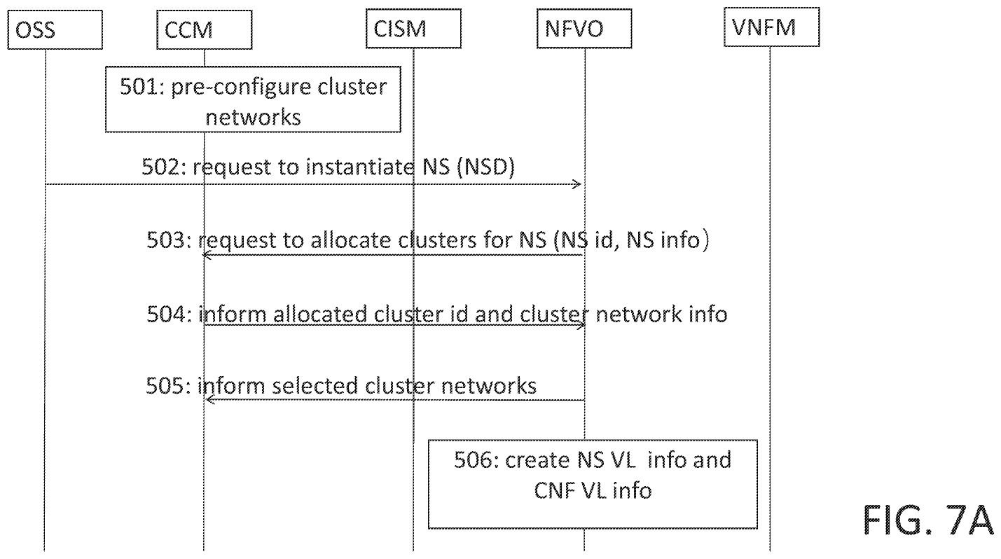

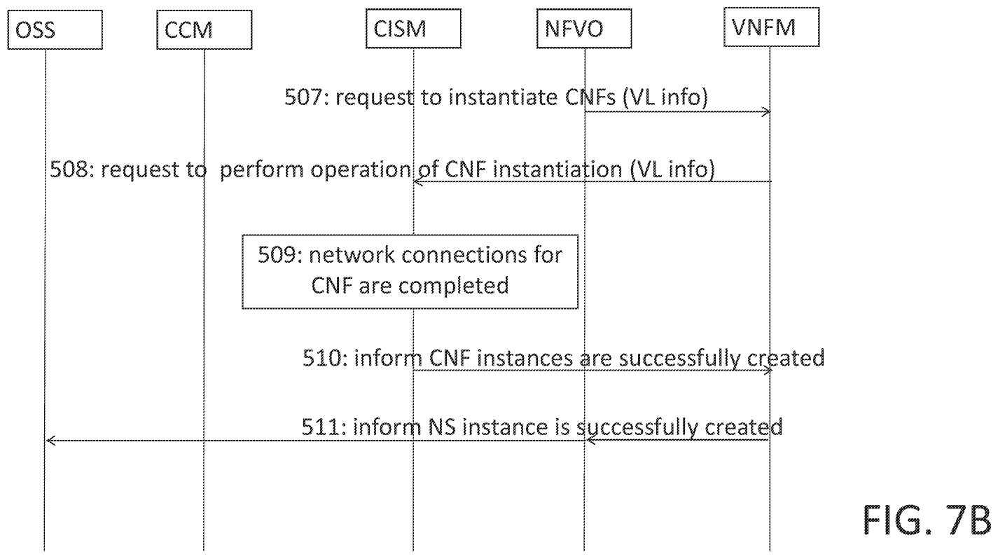

FIG. 7 shows a schematic diagram of a process according to an embodiment of the present disclosure. In this embodiment, the CCM can pre-configure the cluster external networks and cluster internal networks in advance based on pre-configured cluster network profiles or the CIS cluster descriptor.

After receiving the request of an NS instantiation from the OSS, the NFVO requests the CCM to provide the information of the pre-configured cluster external networks and the pre-configured cluster internal networks.

The NFVO selects a part of the pre-configured cluster external networks and the pre-configured cluster internal networks for the external VL networks and the internal VL networks based on the network requirement described in the external VLD of the NSD and the internal VLD of the VND. Then, the NFVO informs the CCM the unoccupied pre-configured cluster external networks and the unoccupied pre-configured cluster internal.

The NFVO maps an external VL with an NS cluster network, and the external CPs with the NS cluster network, then the NFVO may create NS VL information for the network connections among CNFs belonging to one NS.

The NFVO maps internal VLs with CNF cluster networks, and internal CPs with CNF cluster networks, then the NFVO may create CNF VL information for the network connections among CNFCs belonging to one CNF.

Step 501: When the CCM creates the CIS clusters, the CCM also pre-configures multiple cluster external networks and cluster internal networks in advance based on the CIS cluster descriptor. In an embodiment, the CIS cluster descriptor includes the cluster network profiles. In another embodiment, independent the CIS cluster descriptor and the pre-configured cluster network profiles are separated from each other.

Step 502: The OSS requests the NFVO to instantiate an NS (e.g., create an NS instance) with the NSD and all needed VNFDs.

Step 503: After received the request of an NS instantiation from the OSS, the NFVO requests the CCM to allocate the needed CIS clusters for the NS instance, and the information of pre-configured cluster networks. The request message provided to the CCM includes the information of the container resources needed by the NS.

Step 504: The CCM allocates one or more of the CIS clusters for the NS instance, the CCM ensures that these allocated CIS clusters can provide the needed container resources for the NS.

The CCM generates the information of all cluster external networks and cluster internal networks that pre-configured in the allocated CIS clusters.

Step 505: The NFVO selects a part of the pre-configured cluster external/internal networks to be the NS cluster network that corresponds to the NS VL network. The NFVO selects the cluster network when the network types of the selected cluster network and the NS VL network are identical. For example, the network type can be a signal type, a management type, a data type, a charging type, etc.

The NFVO also selects a part of the generated cluster external/internal networks to be the CNF cluster networks that correspond to the CNF VL networks. The NFVO selects the cluster networks when the network types of the selected cluster networks and the CNF VL network are identical. For example, the network type can be a signal type, a management type, a data type, a charging type, etc.

The NFVO informs the CCM the occupied cluster external networks and the occupied cluster internal networks. The CCM can further allocate the unoccupied cluster networks to other NSs if needed.

Step 506: The NFVO associates each object of the external VL to a different network object of the NS cluster network based on the network types thereof. The NFVO associates each object of internal VLs to a different network object of the CNF cluster networks based on the network types thereof.

In the NSD or the VNFD, there is an external CP descriptor or an internal CP descriptor describing the VL objects which the external CPs or internal CPs of the CNFs can connect to. The NFVO may establish the association between the external CPs and the NS cluster external/internal network, and the association between the internal CPs and CNF cluster external/internal networks based on the associated VLs.

The NFVO may create the NS VL information providing the information of the NS cluster external/external network, and the association between the external CPs of the CNFs and NS cluster external/internal network.

The NFVO may create the CNF VL information providing the information of the CNF cluster external/external networks, and the associations between internal CPs of the CNFs and the CNF cluster external/internal networks.

Step 507: The NFVO requests the VNFM to instantiate the CNF with the NS VL information and CNF VL information. The NS VL information is used to create the network connections between the external CPs of the CNFs and the NS cluster external/internal network, the CNF VL information is used to create the network connections between the internal CPs of the CNFCs and the CNF cluster external/internal networks.

Step 508: The VNFM requests the CISM to create the CNF instances and the network connections between the CNFs, and the network connections between the CNFCs inside each CNF with the NS VL information and the CNF information.

Step 509: The CISM performs the creation of the CNF instances, creates the CNFCs (which are composed of containers), allocating compute resources and storage resources for the CNFCs. The CISM connects the external CPs of the CNFs to the associated NS cluster network, and connects the internal CPs of the CNFCs to the CNF cluster networks based on the NS VL information and the CNF VL information.

Step 510: After the CNF instances are successfully instantiated and the network connections are successfully created, the CISM informs the VNFM that the CNF instances are created successfully.

Step 511: The VNFM informs the NFVO the CNF instances is instantiated successfully. After all CNF instances are created successfully, and the network connections between the CNFs are created, the NFVO informs the OSS that the NS instance is created successfully.

In some embodiments of the present disclosure, the CCM creates the cluster external networks and cluster internal networks in the CIS clusters. The MANO can use the created cluster external networks and cluster internal networks as the external VL network (also referred to as external VL) of the NS instance and as the internal VL networks (also referred to as internal VLs) of the CNF instances.

In some embodiments of the present disclosure, there are some options for the CCM to create the cluster external networks and cluster internal networks.

(1) The OSS requests the CCM to pre-create the cluster external networks and the cluster internal networks before the NS LCM or CNF LCM operation based on the cluster network profiles provided by the OSS.

(2) During the NS LCM operation or CNF LCM operation, the NFVO requests the CCM to create the cluster external networks and the cluster internal networks based on the cluster network profiles provided by the NFVO.

(3) The CCM can pre-configure the cluster external networks and the cluster internal networks based on the CIS cluster descriptor or the pre-configured cluster network profiles.

In the case of instantiating the NS or adding a new CNF instance to a NS instance, after the NFVO receives the information of the NS cluster network and the CNF cluster networks, one or more of the following operations may be performed.

The NFVO may map the external VL with the NS cluster network, and map the external CPs with the NS cluster network. Afterward, the NFVO may create NS VL information for the network connections among the CNFs belonging to the NS.

The NFVO or the VNFM may map the internal VLs and the CNF cluster networks, and internal CPs and CNF cluster networks. Afterward, the NFVO may create CNF VL information for the network connections among the CNFCs belonging a CNF.

For mapping the external VL with the NS cluster network, each external VL object can associate to a network object of the NS cluster network based on the same names or the same types.

For mapping external CPs with the NS cluster network, each external CP can associate to a network object of the NS cluster network based on the same associated external VL.

For mapping internal VLs with the CNF cluster networks, each internal VL object can associate to a network object of the CNF cluster networks based on the same names or the same types.

For mapping internal CPs with CNF cluster networks, each internal CP can associate to a network object of the CNF cluster networks based on the same associated internal VL.

The NFVO may request the VNFM to instantiate the CNFs with the NS VL information and the CNF VL information.

The NS VL information is used to create the network connections between the external CPs of the CNFs and the NS cluster external/internal network.

The CNF VL information is used to create the network connections between the internal CPs of the CNFCs and the CNF cluster external/internal networks.

The VNFM may request the CISM to create the CNF instances and the network connections between the CNFs, and the network connections between the CNFCs inside the same CNF with the NS VL information and the CNF information.

The CISM may connect the external CPs of the CNFs to the associated NS cluster network, and connect the internal CPs of the CNFCs to the CNF cluster networks based on the NS VL information and the CNF VL information.

After the CNF instances are successfully instantiated, and the network connections are successfully created, the CISM may inform the VNFM that the CNF instances are created successfully, and the VNFM may inform CNF instances are instantiated successfully.

After all CNFs are created successfully, and the network connections between the CNFs are created, the NFVO may inform the OSS that the NS instance is created successfully.

In some embodiments of the present disclosure, the OSS can perform the operations below.

The OSS can request the CCM to allocate the usable CIS clusters for the NS instance and provides the necessary NS required container resources to the CCM.

The OSS can request the CCM to pre-create the NS cluster network and the CNF cluster networks before an NS LCM and a CNF LCM.

The OSS can provide the NS cluster network profile and the CNF cluster network profiles to the CCM or the NFVO.

The OSS can provide the information of the selected CIS clusters, NS cluster network and CNF cluster networks to the NFVO for the NS or CNF instantiation.

In some embodiments of the present disclosure, the CCM can perform the operations below.

The CCM can pre-configures the cluster external networks and cluster internal networks which do not bind with any specific NS instances or CNF instances.

The CCM can create the NS cluster network associated with the NS ID, and the CNF cluster networks associated with the CNF ID provided by the OSS or MANO.

The CCM allocates one or more CIS clusters for the NS instance, and ensures that these allocated CIS clusters can provide the required container resources for the NS instance.

The CCM informs the OSS or the NFVO the information of allocated CIS clusters.

The CCM can generate the information of all cluster external networks and cluster internal networks that pre-configured in the allocated CIS clusters in case of cluster network pre-configuration.

In some embodiments of the present disclosure, in the case of adding a new CNF to a NS instance, the following operations are performed:

1) The CPD and VLD need to be updated to describe the association between the external CPs of the new CNF and the external VL in the updated NSD.

2) The NFVO updates the existing NS VL information to add the association between the external CPs of the new CNF and the existing NS cluster external/internal network.

3) The NFVO creates the new CNF VL information to provide the information of the new CNF cluster external/external network, and the association between the internal CPs of the new CNF and the new CNF cluster external/internal network.

4) The NFVO requests the VNFM to instantiate the new CNF with the information of the updated NS VL information and the new CNF VL information.

5) The VNFM requests the CISM to create the new CNF instance and the network connections between the new CNF and other existing CNFs, and create the network connections between the CNFCs inside the new CNF with the updated NS VL information and the new CNF VL information.

6) The CISM performs the creation of the new CNF instance, and the CISM connects the external CPs of the new CNF to the associated NS cluster network, and connects the internal CPs of CNFCs to the CNF cluster networks based on the updated NS VL information and the new CNF VL information.

In some embodiments of the present disclosure, in the case of adding a new CNF to a NS instance, the following operations are performed:

1) the NFVO requests the CCM to provide the information of the pre-configured cluster networks of the allocated CIS clusters.

2) The NFVO selects a part of these cluster external/internal networks as the NS cluster network for the NS VL network,

3) The NFVO selects the cluster network when the network types of the selected cluster network and the NS VL network are identical, such as both of the types are signal types, management types, data types, charging types, etc.

4) The NFVO informs the CCM the occupied cluster external networks and cluster internal networks.

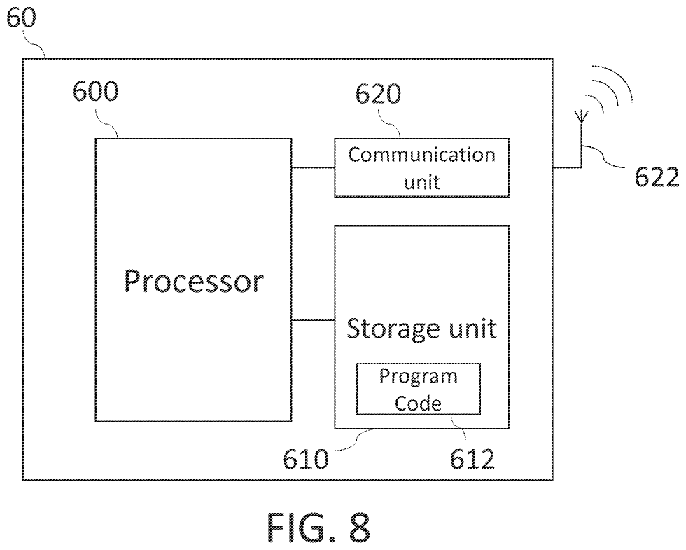

FIG. 8 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform at least part of functionalities of) at least one network function such as an access and mobility management function (AMF), a session management function (SMF), a user place function (UPF), a policy control function (PCF), an OSS, a CCM, a CISM, an NFVO, a VNFM, etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment) or another wireless network node.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of claims. Thus, the disclosure is not intended to be limited to the implementations shown herein, but is to be accorded the widest scope consistent with the novel features and principles disclosed herein, as recited in the claims below.

1. A wireless communication method:
creating, by an orchestrator node, virtual link (VL) information according to virtual link descriptors (VLDs) and information of created cluster networks, wherein the VL information comprises the information of the created cluster networks mapping to relevant VLs, and an association between connection points (CPs) and the created cluster networks; and
transmitting, by the orchestrator node to a virtualized network function manager node, a Containerized Virtualized Network Function (CNF) instantiating request comprising the VL information for instantiating CNFs for a Network Service (NS).

2. The wireless communication method of claim 1, further comprising:
creating, by the orchestrator node, NS VL information according to an external VLD of a Network Service Descriptor (NSD), wherein the NS VL information comprises information of a created NS cluster network and an association between external CPs of the CNFs and the created NS cluster network, and wherein the CNF instantiating request comprises the NS VL information.

3. The wireless communication method of claim 1, further comprising:
creating, by the orchestrator node, CNF VL information according to an internal VLD of a Virtualized Network Function Descriptor (VNFD), wherein the CNF VL information comprises information of created CNF cluster networks and an association between internal CPs of the CNFs and the created CNF cluster networks, and wherein the CNF instantiating request comprises the CNF VL information.

4. The wireless communication method of claim 1, further comprising:
receiving, by the orchestrator node from an operation support node, an NS instantiating request comprising an NSD, a VNFD, and attribute information of the cluster networks.

5. The wireless communication method of claim 1, further comprising:
receiving, by the orchestrator node from a container cluster manager node, the information of the created cluster networks.

6. The wireless communication method of claim 5, further comprising:
transmitting, by the orchestrator node to the container cluster manager node, a creating request comprising cluster network profiles to request the container cluster manager node to create the cluster networks according to the cluster network profiles,
wherein the cluster network profiles are generated by the orchestrator node based on the VLDs, and the VLDs comprises attribute information for creating the cluster networks.

7. The wireless communication method of claim 5, further comprising:
transmitting, by the orchestrator node to the container cluster manager node, an allocation request to request the container cluster manager node to allocate one or more Container Infrastructure Service (CIS) clusters for the NS; and
receiving, by the orchestrator node from the container cluster manager node, information of one or more allocated CIS clusters.

8. The wireless communication method of claim 5, further comprising:
receiving, by the orchestrator node from an operation support node, an NS instantiating request comprising an NSD and a VNFD and cluster network profiles.

9. The wireless communication method of claim 5, wherein the cluster networks are pre-configured by the container cluster manager node.

10. The wireless communication method of claim 1, further comprising:
updating, by the orchestrator node, the VL information according to updated VLDs; and
transmitting, by the orchestrator node to the virtualized network function manager node, a new CNF instantiating request comprising the updated VL information for instantiating a new CNF for the NS,
wherein the wireless communication method further comprises:
updating, by the orchestrator node, NS VL information according to an external VLD of an updated NSD,
wherein the wireless communication method further comprises:
creating, by the orchestrator node, new CNF VL information for the new CNF according to an internal VLD of a new VNFD, and
wherein the wireless communication method further comprises:
transmitting, by the orchestrator node to a container cluster manager node, a creating request comprising a new CNF cluster network profile to control the container cluster manager node to create new cluster networks according to the new CNF cluster network profile; and
receiving, by the orchestrator node to the container cluster manager node, information of the new cluster networks.

11. A wireless communication method comprising:
receiving, by a virtualized network function manager node from an orchestrator node, a Containerized Virtualized Network Function (CNF) instantiating request comprising virtual link (VL) information for instantiating CNFs for a Network Service (NS),
wherein the VL information comprises information of created cluster networks mapping to relevant VLs, and an association between connection points (CPs) and the cluster networks.

12. The wireless communication method of claim 11, wherein the VL information comprises NS VL information comprising information of an NS cluster network and an association between external CPs of the CNFs and the NS cluster network, and wherein the CNF instantiating request comprises the NS VL information.

13. The wireless communication method of claim 11, wherein the VL information comprises CNF VL information comprising information of CNF cluster networks and an association between internal CPs of the CNFs and the CNF cluster networks, and wherein the CNF instantiating request comprises the CNF VL information.

14. The wireless communication method of claim 11, further comprising:
creating, by the virtualized network function manager node, CNF VL information according to an internal VLD of a Virtualized Network Function Descriptor (VNFD), wherein the CNF VL information comprises information of CNF cluster networks and an association between internal CPs of the CNFs and the CNF cluster networks, and wherein the CNF instantiating request comprises the CNF VL information.

15. The wireless communication method of claim 11, further comprising:
transmitting, by the virtualized network function manager node to a service manager node, the VL information to allow the service manager to create CNF instances, create connections between the CNFs, create connections between Containerized Virtualized Network Function Components, CNFCs, in each CNFs, connect external CPs of the CNFs to an associated NS cluster network, and connect internal CPs of the CNFCs to CNF cluster networks.

16. The wireless communication method of claim 11, further comprising:
transmitting, by the virtualized network function manager node to a service manager node, updated VL information to allow the service manager to create connections between CNFCs in a new CNF and create connections between external CPs of the new CNF and an existing NS cluster network.

17. A wireless communication method comprising:
receiving, by a service manager node from a virtualized network function manager node, virtual link (VL) information comprising information of created cluster networks and an association between connection points (CPs) and the cluster networks; and
instantiating, by the service manager node, Containerized Virtualized Network Functions (CNFs) for a Network Service (NS) according to the VL information.

18. The wireless communication method of claim 17, further comprising:
creating, by the service manager node, connections between the CNFs;
creating, by the service manager node, connections between Containerized Virtualized Network Function Components (CNFCs) in each CNFs;
connecting, by the service manager node, external CPs of the CNFs to an associated NS cluster network; and
connecting, by the service manager node, internal CPs of the CNFCs to CNF cluster networks.

19. The wireless communication method of claim 17, further comprising:
creating, by the service manager node, an NS cluster network and CNF cluster networks according to a NS cluster network profile and CNF cluster network profiles.

20. The wireless communication method of claim 17, further comprising:
receiving, by the service manager node from the virtualized network function manager node, updated VL information; and
creating, by the service manager node, network connections for a new CNF instance according to the updated VL information.
